(19) United States
(12) Patent Application Publication
(10) Pub. No.: US 2025/0183370 A1
(43) Pub. Date: Jun. 5, 2025

(54) FLUORINATED ELECTROLYTE FOR BATTERY CELL INCLUDING CATHODE ELECTRODE WITH LITHIUM- AND MANGANESE-RICH (LMR) ACTIVE

(71) Applicant: GM GLOBAL TECHNOLOGY OPERATIONS LLC, Detroit, MI (US)

(72) Inventors: Vamakshi YADAV, Sterling Heights, MI (US); Lei WANG, Rochester Hills, MI (US); Chuanlong WANG, Troy, MI (US); Raneen TAHA, Sterling Heights, MI (US)

(21) Appl. No.: 18/525,960

(22) Filed: Dec. 1, 2023

(51) Int. Cl. H01M 10/0567; H01M 4/02; H01M 4/40; H01M 10/052; H01M 10/0568; H01M 50/46

(52) U.S. Cl. CPC H01M 10/0567; H01M 4/405; H01M 10/052; H01M 10/0568; H01M 50/46; H01M 2004/027; H01M 2004/028; H01M 2300/0025

(57) ABSTRACT

A battery cell includes a battery cell stack including C cathode electrodes including lithium- and manganese-rich cathode active (LMR) material, A anode electrodes including an anode active material, and S separators, where C, A and S are integers greater than one. An enclosure encloses the battery cell stack and electrolyte. The electrolyte comprises a lithium salt and a mixture of a fluorinated carbonate and a fluorinated ester.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including cathode electrodes including lithium- and manganese-rich cathode active material and fluorinated electrolyte.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes a battery cell stack including C cathode electrodes including lithium- and manganese-rich cathode active (LMR) material, A anode electrodes including an anode active material, and S separators, where C, A and S are integers greater than one. An enclosure encloses the battery cell stack and electrolyte. The electrolyte comprises a lithium salt and a mixture of a fluorinated carbonate and a fluorinated ester.

In other features, a ratio of the fluorinated carbonate to the fluorinated ester is in a range from 60:40 to 20:80 volume %. The lithium salt is in a range from 0.5 M to 5 M. The lithium salt is in a range from 1 M to 2 M. The lithium salt is selected from a group consisting of LiPF6, LiClO4, LiBF4, LiAsF6, LiTFSI, LiFSI, LiDFOB, LiBOB, LiPO2F2, and combinations thereof. The fluorinated carbonate is selected from a group consisting of fluoroethylene carbonate (FEC), bis(2,2,2-trifluoroethyl) carbonate, methyl 2,2,2-trifluoroethyl carbonate (FEMC), difluoro ethylene carbonate (FDEC), and combinations thereof.

In other features, the fluorinated ester is selected from a group consisting of 2,2,2-trifluoroethyl acetate (TFEA), methyl pentafluoro propionate (MTFP), methyl 3,3,3-trifluoropropionate (MPFP), 2,2,2-tifluoroethyl butyrate (TFEB), and combinations thereof. The electrolyte further comprises a non-fluorinated carbonate. A ratio of the fluorinated carbonate and the fluorinated ester to the non-fluorinated carbonate is in a range from 20:80 to 80:20 volume %. The fluorinated carbonate is selected from a group consisting of ethylene carbonate (EC), ethyl methyl carbonate (EMC), diethyl carbonate (DEC), dimethyl carbonate (DMC), and combinations thereof.

In other features, the anode active material is selected from a group consisting of silicon oxide/graphite, graphite, silicon, silicon oxide, lithium metal, and combinations thereof. The battery cell operates in a voltage window in a range from 2.0V to 5.0V and at a charging rate of the battery cell is in a range from C/100 to 6 C.

An electrolyte for a battery cell includes a lithium salt in a range from 0.5 M to 5 M; and a mixture of a fluorinated carbonate and a fluorinated ester. A ratio of the fluorinated carbonate to the fluorinated ester is in a range from 60:40 to 20:80 volume %.

In other features, the lithium salt is in a range from 1 M to 2 M. The lithium salt is selected from a group consisting of LiPF6, LiClO4, LiBF4, LiAsF6, LiTFSI, LiFSI, LiDFOB, LiBOB, LiPO2F2, and combinations thereof. The fluorinated carbonate is selected from a group consisting of fluoroethylene carbonate (FEC), bis(2,2,2-trifluoroethyl) carbonate, methyl 2,2,2-trifluoroethyl carbonate (FEMC), difluoro ethylene carbonate (FDEC), and combinations thereof. The fluorinated ester is selected from a group consisting of 2,2,2-trifluoroethyl acetate (TFEA), methyl pentafluoro propionate (MTFP), methyl 3,3,3-trifluoropropionate (MPFP), 2,2,2-tifluoroethyl butyrate (TFEB), and combinations thereof.

The electrolyte further comprises a non-fluorinated carbonate. A ratio of the fluorinated carbonate and the fluorinated ester to the non-fluorinated carbonate is in a range from 20:80 to 80:20 volume %. The fluorinated carbonate is selected from a group consisting of ethylene carbonate (EC), ethyl methyl carbonate (EMC), diethyl carbonate (DEC), dimethyl carbonate (DMC), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of a battery cell including anode electrodes, LMR cathode electrodes, separators, and fluorinated electrolyte in a battery cell enclosure according to the present disclosure;

FIG. 2 is a side cross sectional view of the LMR cathode electrode according to the present disclosure;

FIG. 3 is a side cross sectional view of the anode electrode according to the present disclosure;

FIG. 4A is a graph showing capacity as a function of cycles for battery cells including the LMR cathode electrodes using different fluorinated electrolyte mixtures according to the present disclosure;

FIG. 4B is a graph showing discharge capacity retention percentage as a function of cycles for battery cells including the LMR cathode electrodes using different fluorinated electrolyte mixtures according to the present disclosure;

FIG. 4C is a graph showing ionic conductivity for various fluorinated electrolyte mixtures according to the present disclosure;

FIG. 5A is a graph showing capacity as a function of cycles for battery cells including the LMR cathode electrodes using different fluorinated electrolyte mixtures according to the present disclosure;

FIG. 5B is a graph showing discharge capacity retention percentage as a function of cycles for battery cells including the LMR cathode electrodes using different fluorinated electrolyte mixtures according to the present disclosure; and

FIG. 5C is a graph showing ionic conductivity for various fluorinated electrolyte mixtures according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Li- and Mn-rich (LMR) cathode active materials have higher specific capacity as compared to convention cathode active materials such as lithium iron phosphate (LFP) and lithium nickel manganese cobalt oxide (NMC). However, non-fluorinated carbonate-based electrolyte solvents commonly used with LMR chemistry undergo severe decomposition at high voltage (e.g., 4.3V or higher) resulting in poor discharge capacity retention, gas generation during cycling, and/or low columbic efficiency.

To improve the cycling performance of LMR cathodes when operating at higher voltages (e.g., 4.3V or higher), the battery cells according to the present disclosure use electrolyte including fluorinated solvents as a stable electrolyte solvent. The fluorinated solvents include a combination of fluorinated esters and fluorinated carbonates. The fluorinated carbonates such as fluoroethylene carbonate (FEC) fabricate a stable cathode electrolyte interface (CEI) while the fluorinated ester (e.g., trifluoroacetate (TFEA)) has weak coordination ability and low viscosity which facilitates good ionic conductivity.

The battery cells according to the present disclosure use a combination of fluorinated esters and fluorinated carbonates to improve capacity retention of the LMR cathode electrode when the battery cell cycles at high voltages. The concentration of fluorinated esters in the electrolyte mixture is optimized to boost ionic conductivity of the electrolyte without comprising capacity retention. Fluorinated esters and carbonates described below are compatible with LMR cathode active materials.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Electrolyte 52 including lithium salt and a solvent including fluorinated esters, fluorinated carbonates, and optionally non-chlorinated carbonates is added to the enclosure 50 as will be described further below. The C cathode electrodes 20-1, 20-2, . . . , and 20-C include cathode active material layers 24 arranged on one or both sides of a cathode current collector 26.

During charging/discharging, the A anode electrodes 40 and the C cathode electrodes 20 exchange lithium ions. The A anode electrodes 40-1, 40-2, . . . , and 40-A include anode active material layers 42 arranged on one or both sides of the anode current collectors 46. In some examples, the cathode active material layers 24 and/or the anode active material layers comprise coatings including one or more active materials, one or more conductive additives, and/or one or more binder materials that are applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

In some examples, the electrolyte 52 includes a lithium salt and a mixture of one or more fluorinated carbonates and one or more fluorinated esters. In some examples, the lithium salt is selected from a group consisting of LiPF₆, LiClO₄, LiBF₄, LiAsF₆, LiTFSI, LiFSI, LiDFOB, LiBOB, LiPO₂F₂, and combinations thereof. In some examples, the electrolyte mixture further includes one or more non-fluorinated carbonates.

Examples of the fluorinated carbonate includes fluoroethylene carbonate (FEC), bis(2,2,2-trifluoroethyl) carbonate, methyl 2,2,2-trifluoroethyl carbonate (FEMC), difluoro ethylene carbonate (FDEC), and combinations thereof. Examples of the fluorinated ester include 2,2,2-trifluoroethyl acetate (TFEA), methyl pentafluoro propionate (MTFP), methyl 3,3,3-trifluoropropionate (MPFP), 2,2,2-tifluoroethyl butyrate (TFEB), and combinations thereof. Examples of the non-fluorinated carbonate include ethylene carbonate (EC), ethyl methyl carbonate (EMC), diethyl carbonate (DEC), dimethyl carbonate (DMC), and combinations thereof.

In some examples, the ratio of the fluorinated carbonate to the fluorinated ester is in a range from 60:40 to 20:80 volume %. The lithium salt is in a range from 0.5 M to 5 M. The lithium salt is in a range from 1 M to 2 M. In some examples, a non-fluorinated carbonate is added to the mixture of the fluorinated carbonate and the fluorinated ester. If used, the ratio of the fluorinated carbonate and the fluorinated ester to the non-fluorinated carbonate is in a range from 20:80 to 80:20 volume %.

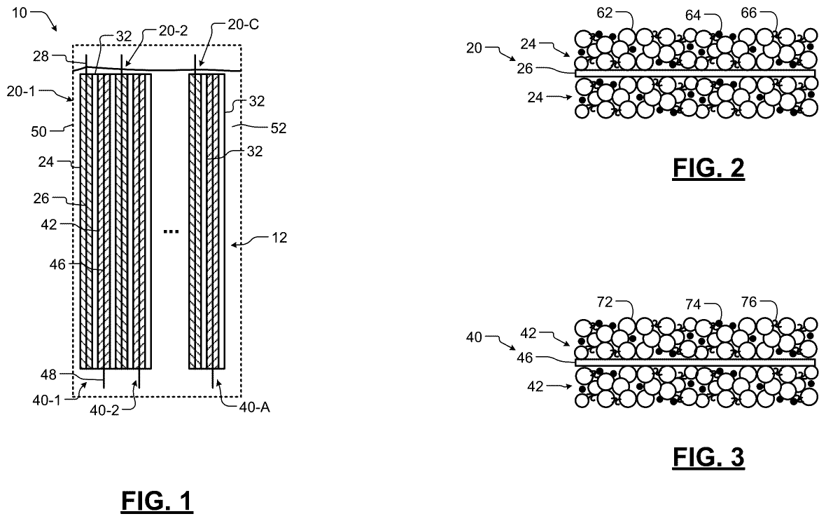

Referring now to FIG. 2, the C cathode electrodes 20 are shown in further detail. The cathode active material layer 24 of the C cathode electrodes 20 includes cathode active material 62, an optional conductive additive 64, and an optional binder 66. In some examples, the cathode active material 62 includes Li- and Mn-rich cathode active material.

Referring now to FIG. 3, the A anode electrode 40 are shown in further detail. The anode active material layer 42 of the anode electrode 40 includes anode active material 72, an optional conductive additive 74, and an optional binder 76. In some examples, the anode active material 72 includes SiOₓ/graphite, graphite, silicon, SiOₓ, lithium metal, and combinations thereof.

In some examples, the LMR battery cell operates in a voltage range from 2.0V to 5.0 V. In some examples, the charging rate of the battery cell is in a range from C/100 to 6 C. In some examples, the battery cell has an N/P ratio in a range from 1 to 3.

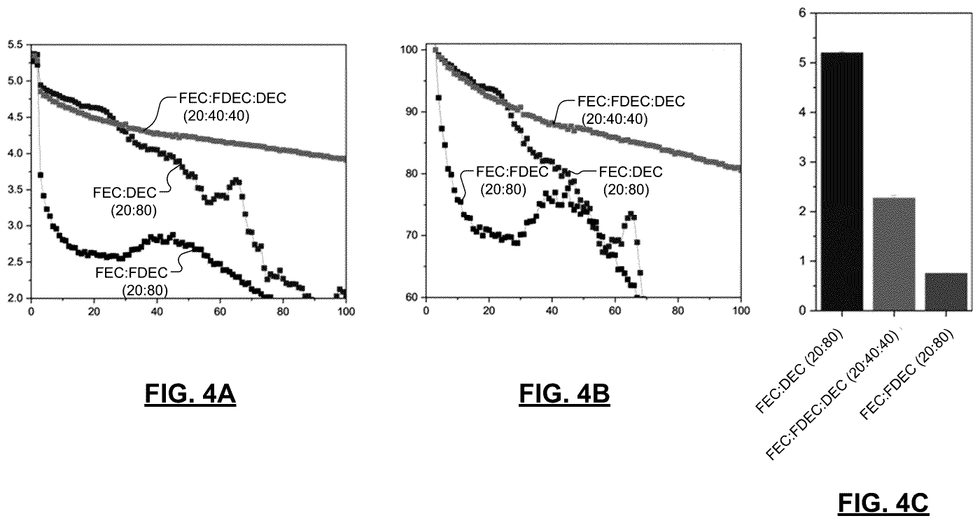

Referring now to FIGS. 4A to 4C, the fluorinated solvents are more stable at higher oxidation potentials. In some examples, the battery cell includes LMR as the cathode active material and 5.5% SiOx-graphite as the anode active material. In FIGS. 4A and 4B, capacity and discharge capacity retention % are shown as a function of cycles for electrolytes including a mixture of FEC:DEC (at a ratio of 20:80 volume %), a mixture of FED:FDEC (at a ratio of 20:80 volume %), and a mixture of FEC:FDEC:DEC (at a ratio of 20:40:40 volume %). The battery cell was operated within a voltage range from 2 V to 4.6V at C/3 charge rate. In FIG. 4C, ionic conductivities of the electrolytes are shown. As can be seen from FIGS. 4A to 4C, partial replacement of non-fluorinated carbonates (e.g., DEC) with fluorinated carbonates (e.g., FDEC) is more stable than non-fluorinated carbonates alone but with significantly lower ionic conductivity.

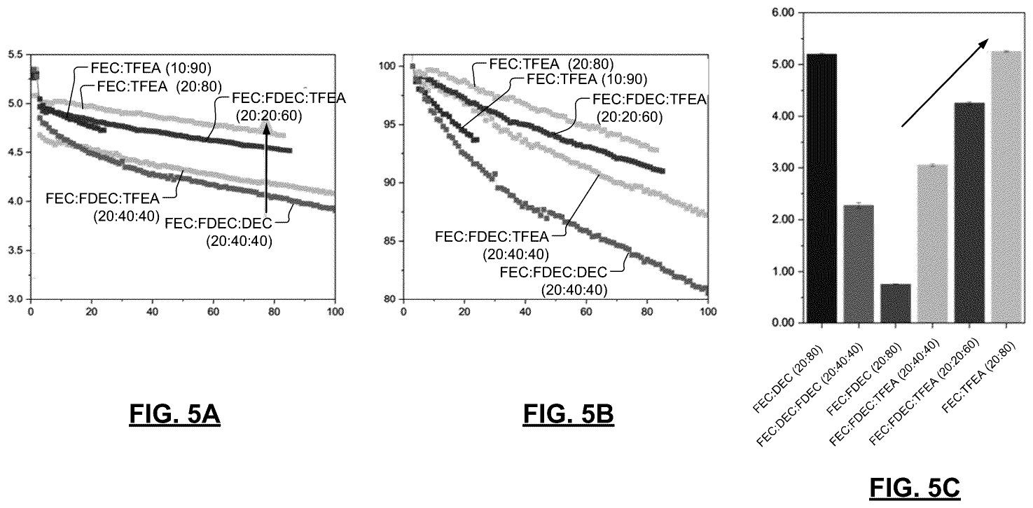

Referring now to FIGS. 5A to 5C, capacity and discharge capacity retention % are shown as a function of cycles for various electrolytes. In FIG. 5A, the electrolytes include a mixture of FEC:DEC:FDEC (at a ratio of 20:40:40 volume %), a mixture of FED:FDEC (at a ratio of 20:80 volume %), a mixture of FEC:FDEC:TFEA (at a ratio of 20:40:40 volume %), a mixture of FEC:FDEC:TFEA (at a ratio of 20:20:60 volume %) and a mixture of FEC:TFEA (at a ratio of 20:80 volume %). In FIG. 5C, ionic conductivities of the electrolyte mixtures are shown. The ionic conductivity increases with increasing concentrations of fluorinated esters (as shown by arrows in FIGS. 5A and 5C) up to about 80 volume % and falls off at higher concentrations of the fluorinated esters. As can be seen, the addition of fluorinated esters (e.g., TFEA) to the electrolyte mixture increases cycling stability without compromising ionic conductivity.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a battery cell stack including:
C cathode electrodes including lithium- and manganese-rich cathode active (LMR) material;
A anode electrodes including an anode active material; and
S separators, where C, A and S are integers greater than one; and
an enclosure including the battery cell stack and electrolyte,
wherein the electrolyte comprises a lithium salt and a mixture of a fluorinated carbonate and a fluorinated ester.

2. The battery cell of claim 1, wherein a ratio of the fluorinated carbonate to the fluorinated ester is in a range from 60:40 to 20:80 volume %.

3. The battery cell of claim 1, wherein the lithium salt is in a range from 0.5 M to 5 M.

4. The battery cell of claim 1, wherein the lithium salt is in a range from 1 M to 2 M.

5. The battery cell of claim 1, wherein the lithium salt is selected from a group consisting of LiPF₆, LiClO₄, LiBF₄, LiAsF₆, LiTFSI, LiFSI, LiDFOB, LiBOB, LiPO₂F₂, and combinations thereof.

6. The battery cell of claim 1, wherein the fluorinated carbonate is selected from a group consisting of fluoroethylene carbonate (FEC), bis(2,2,2-trifluoroethyl) carbonate, methyl 2,2,2-trifluoroethyl carbonate (FEMC), difluoro ethylene carbonate (FDEC), and combinations thereof.

7. The battery cell of claim 1, wherein the fluorinated ester is selected from a group consisting of 2,2,2-trifluoroethyl acetate (TFEA), methyl pentafluoro propionate (MTFP), methyl 3,3,3-trifluoropropionate (MPFP), 2,2,2-tifluoroethyl butyrate (TFEB), and combinations thereof.

8. The battery cell of claim 1, wherein the electrolyte further comprises a non-fluorinated carbonate.

9. The battery cell of claim 8, wherein a ratio of the fluorinated carbonate and the fluorinated ester to the non-fluorinated carbonate is in a range from 20:80 to 80:20 volume %.

10. The battery cell of claim 1, wherein the fluorinated carbonate is selected from a group consisting of ethylene carbonate (EC), ethyl methyl carbonate (EMC), diethyl carbonate (DEC), dimethyl carbonate (DMC), and combinations thereof.

11. The battery cell of claim 1, wherein the anode active material is selected from a group consisting of silicon oxide/graphite, graphite, silicon, silicon oxide, lithium metal, and combinations thereof.

12. The battery cell of claim 1, wherein the battery cell operates in a voltage window in a range from 2.0V to 5.0V and at a charging rate of the battery cell is in a range from C/100 to 6 C.

13. An electrolyte for a battery cell including
a lithium salt in a range from 0.5 M to 5 M; and
a mixture of a fluorinated carbonate and a fluorinated ester,
wherein a ratio of the fluorinated carbonate to the fluorinated ester is in a range from 60:40 to 20:80 volume %.

14. The electrolyte of claim 13, wherein the lithium salt is in a range from 1 M to 2 M.

15. The electrolyte of claim 13, wherein the lithium salt is selected from a group consisting of LiPF₆, LiClO₄, LiBF₄, LiASF₆, LiTFSI, LiFSI, LiDFOB, LiBOB, LiPO₂F₂, and combinations thereof.

16. The electrolyte of claim 13, wherein the fluorinated carbonate is selected from a group consisting of fluoroethylene carbonate (FEC), bis(2,2,2-trifluoroethyl) carbonate, methyl 2,2,2-trifluoroethyl carbonate (FEMC), difluoro ethylene carbonate (FDEC), and combinations thereof.

17. The electrolyte of claim 13, wherein the fluorinated ester is selected from a group consisting of 2,2,2-trifluoroethyl acetate (TFEA), methyl pentafluoro propionate (MTFP), methyl 3,3,3-trifluoropropionate (MPFP), 2,2,2-tifluoroethyl butyrate (TFEB), and combinations thereof.

18. The electrolyte of claim 13, wherein the electrolyte further comprises a non-fluorinated carbonate.

19. The electrolyte of claim 18, wherein a ratio of the fluorinated carbonate and the fluorinated ester to the non-fluorinated carbonate is in a range from 20:80 to 80:20 volume %.

20. The electrolyte of claim 18, wherein the fluorinated carbonate is selected from a group consisting of ethylene carbonate (EC), ethyl methyl carbonate (EMC), diethyl carbonate (DEC), dimethyl carbonate (DMC), and combinations thereof.
